(19) United States
(12) Patent Application Publication
(10) Pub. No.: US 2012/0020079 A1
(43) Pub. Date: Jan. 26, 2012

(54) SURFACE LIGHT SOURCE DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/070,488

(22) Filed: Mar. 24, 2011

(30) Foreign Application Priority Data
Jul. 26, 2010 (CN) 201010236721.4

(51) Int. Cl. F21V 13/10; F21V 5/02

(52) U.S. Cl. 362/235

(57) ABSTRACT

A surface light source device includes a number of light sources, a first prism sheet and a second prism sheet. The light sources are distributed on a bottom plate of a housing. The first prism sheet and the second prism sheet are arranged above the light sources in that order. The light sources and the first prism sheets are spaced by a first predefined distance, and the first prism sheets and the second prism sheets are spaced by a second predefined distance. The light emitting surface of the first prism sheet includes a number of substantially parallel elongated protrusions, and the light emitting surface of the second prism sheet includes a number of elongated V-shaped ridge structures extending along different directions. Light beams emitted by the light sources are substantially diffused after passing through the first and the second prism sheet and become surface light beams.

### BACKGROUND

1. Technical Field

The present disclosure relates to surface light source devices and, particularly, to a surface light source device employing double prism sheets.

2. Description of Related Art

A light-emitting diode (LED) is a point light source with a small radiation angle and strong directionality, and is now being widely used in lighting devices. A number of LEDs distributed in rows on the lighting device is usually needed to obtain a large lighting area. However, when a number of LED light sources illuminate on an object from different directions at the same time, a number of shadows of the illuminated object will be produced. Furthermore, high brightness from the LEDs cause light spots on the lighting surface of the LED lighting device. An extra light diffusion film is needed to avoid the shadows, and reduce the light spots and achieve a uniform lighting surface. However, the light diffusion film may absorb part of the light from the light-emitting diodes. Thus, the brightness of light illumination of the lighting device is reduced.

Therefore, what is needed is a surface light source device to overcome the above-mentioned shortcomings

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a side cross-sectional view of a surface light source device according to an embodiment.

FIG. 2 is a partial view of a first prism sheet of the surface light source device of FIG. 1.

FIG. 3 is a schematic, isometric view of a second prism sheet of the surface light source device of FIG. 1.

FIG. 4 is a schematic view showing light beams passing through the first prism sheet of FIG. 2.

### DETAILED DESCRIPTION

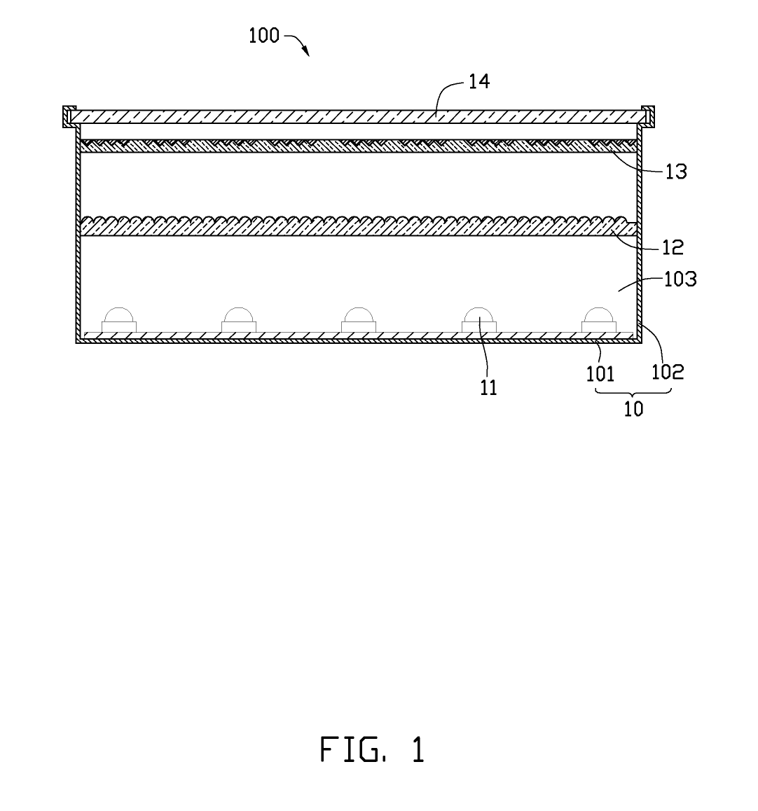

Referring to FIG. 1, a surface light source device 100 is illustrated. The surface light source device 100 includes a housing 10, a number of light sources 11, a first prism sheet 12, a second prism sheet 13, and a transparent plate 14. The housing 10 includes a bottom plate 101 and a number of sidewalls 102 extending from the periphery of the bottom plate 101, which cooperatively define a space 103. The housing 10 can reflect some of the light upwards. In the embodiment, the housing 10 is made of metal or plastic material with high reflectivity rate. In an alternative embodiment, the housing 10 may have a high reflective coating applied on its internal sidewalls for improving light reflectivity rate.

The light sources 11 are distributed on the bottom plate 101. In the embodiment, the light sources 11 are a number of point light sources, such as light-emitting diodes. In an alternative embodiment, a number of linear light sources, such as cold cathode tubes, can replace the point light sources.

The first prism sheet 12 is arranged above the light sources 11, and the second prism sheet 13 is arranged above the first prism sheet 12. The transparent plate 14 is arranged above the second prism sheet 13 and covers the housing 10. Light beams emitted by the light sources 11 are substantially diffused after passing through the first prism sheet 12 and the second prism sheet 13, and finally become surface light beams exiting the transparent plate 14.

In the embodiment, the first prism sheet 12, the second prism sheet 13 and the transparent plate 14 are substantially parallel to the bottom plate 101. The light sources 11 and the first prism sheets 12 are spaced by a first predefined distance, and the first prism sheets 12 and the second prism sheets 13 are spaced by a second predefined distance.

The transparent plate 14 prevents the second prism sheet 13 from being contaminated, or scratched. In the embodiment, the transparent plate 14 can be transparent glass, frosted glass, or transparent plastic plate.

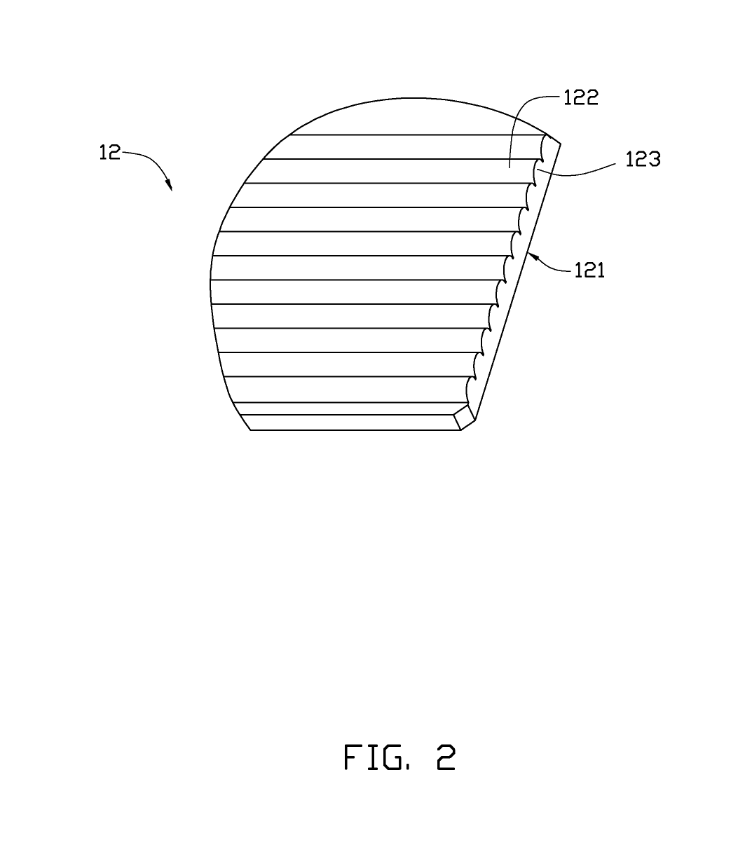

Referring to FIG. 2, the first prism sheet 12 is made of transparent plastic material, and includes a light incident surface 121 and a light emitting surface 122. The light incident surface 121 and the light emitting surface 122 are at opposite sides of the first prism sheet 12. In the embodiment, the light incident surface 121 is a planar surface, and faces the light sources 11. The light emitting surface 122 includes a number of first diffusion structures 123. In the embodiment, the first diffusion structures 123 are in the form of a number of substantially parallel elongated protrusions 123 distributed side by side. The cross-section of each elongated protrusion 123, cut along a line perpendicular to the longitudinal direction of the protrusions 123, can be arc-shaped, oval-shaped, or wave-shaped.

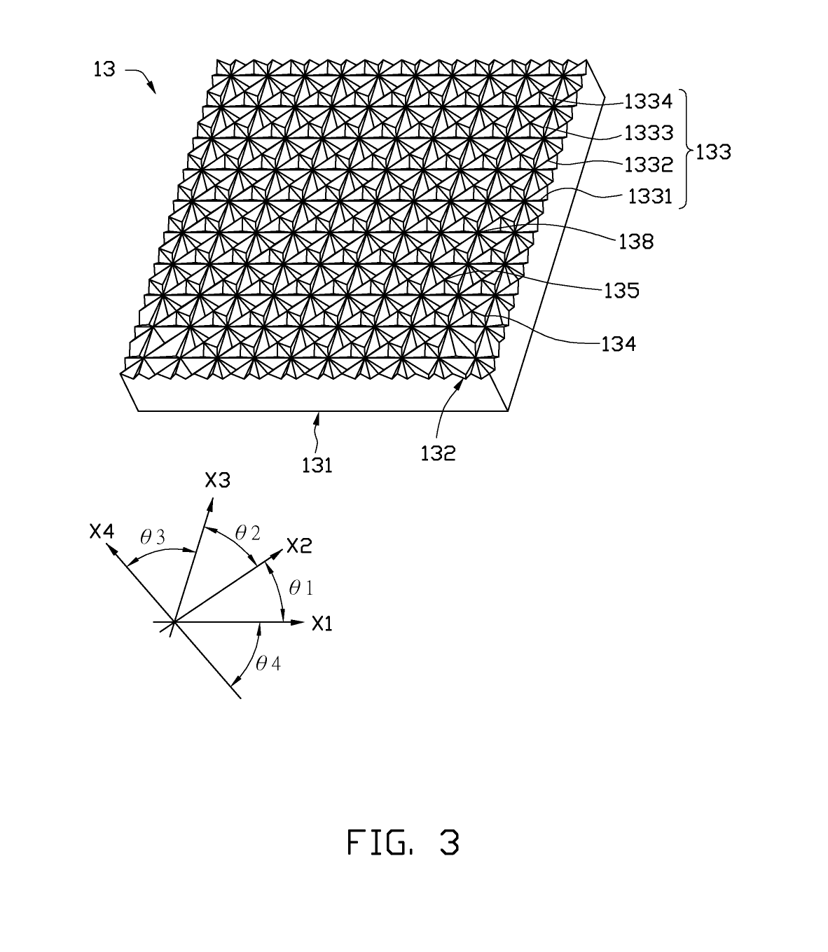

Referring to FIG. 3, the second prism sheet 13 is made of transparent plastic material, and includes a light incident surface 131 and a light emitting surface 132. The light incident surface 131 and the light emitting surface 132 are at opposite sides of the second prism sheet 13. In the embodiment, the light incident surface 131 is a planar surface, and faces the light emitting surface 122 of the first prism sheet 12. The light emitting surface 132 includes a number of second diffusion structures 133. In the embodiment, the second diffusion structures 133 are in the form of a number of elongated V-shaped ridge structures extending along at least two different directions and being mutually staggered.

In the embodiment, the V-shaped ridge structures 133 extend along four different directions, and include a number of first elongated V-shaped ridge structures 1331 extending along a first direction X1, a number of second elongated V-shaped ridge structures 1332 extending along a second direction X2, a number of third elongated V-shaped ridge structures 1333 extending along a third direction X3, and a number of fourth elongated V-shaped ridge structures 1334 extending along a fourth direction X4.

In the embodiment, the first direction X1 and the second direction X2 define a first included angle θ1. The second direction X2 and the third direction X3 define a second included angle θ2. The third direction X3 and the fourth direction X4 define a third included angle θ3. The first direction X1 and the fourth direction X4 define a fourth included angle θ4. In the embodiment, each of the angles θ1, θ2, θ3 and θ4 is about 45 degrees.

Each three V-shaped ridge structures 133 extending along different directions cooperatively define a micro-dent 134. Each of the micro-dents 134 includes three side surfaces connected in order. Each four adjacent micro-dents 134 cooperatively define a first micro-protrusion 135, and each eight adjacent micro-dents 134 cooperatively define a second micro-protrusion 138. With such structure, the V-shaped ridge structures 133 can diffuse the incident light into a number of virtual light sources gathering in the vertexes of the first micro-protrusions 135 and the second micro-protrusions 138.

In use, light beams emitted by the light sources 11 enter the first prism sheet 12. Because the elongated protrusions 123 on the light emitting surface of the first prism sheet 12 are curved, the incident light beams are refracted, reflected, or diffracted. As a result, light beams emitting from the first prism sheet 13 are more uniform than they are passing through a light emitting surface of a typical optical plate.

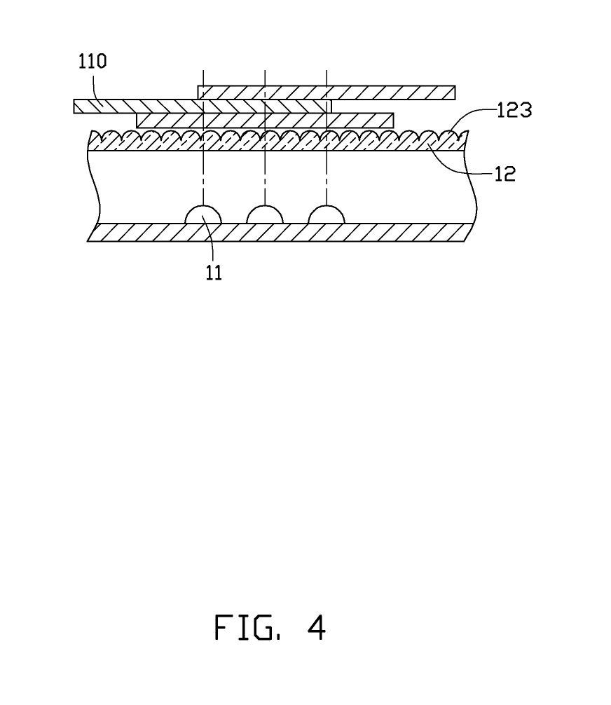

In the embodiment, as shown in FIG. 4, light beams emitted by each light source 11 each forms a uniform linear light source 110 on the light emitting surface 122 of the first prism sheet 12, and the longitudinal direction of each linear light source is substantially perpendicular to that of the protrusions 123.

If the spacing between each two neighboring light sources 11 is small enough, the neighboring linear light sources 110 overlap in the first prism sheet 12 in their longitudinal direction, which creates a light mixing effect. If the first prism sheet 12 is spaced further from the light sources 11, the length of each linear light source is longer, and the linear light sources overlap more, which achieve a better light mixing effect.

Furthermore, the light beams exiting the first prism sheet 12 pass through the air layer and then enter the second prism sheet 13. The incident light beams are further refracted, scattered, reflected, or diffracted by the V-shaped ridge structures 123 of the first prism sheet 12, and are thus further diffused. As a result, the light beams emitting from the transparent plate 14 become surface light beams, providing a good uniform optical performance, which avoids shadows and light spots.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A surface light source device comprising:
a housing comprising a bottom plate;
a plurality of light sources distributed on the bottom plate;
a first prism sheet arranged above the light sources; and
a second prism sheet arranged above the first prism sheet;
wherein, each of the first prism sheet and the second prism sheet comprises a light incident surface and a light emitting surface opposite to the light incident surface;
the light emitting surface of the first prism sheet comprises a plurality of substantially parallel elongated protrusions, and the light emitting surface of the second prism sheet comprises a plurality of elongated V-shaped ridge structures extending along different directions;
the light sources and the first prism sheets are spaced by a first predefined distance, and the first prism sheets and the second prism sheets are spaced by a second predefined distance; and
light beams emitted by the light sources are substantially diffused after passing through the first prism sheet and the second prism sheet and become surface light beams.

2. The surface light source device of claim 1, wherein a cross-section of each elongated protrusions of the first prism sheet, cut along a line perpendicular to the longitudinal direction of the elongated protrusions, is arc-shaped, oval-shaped, or wave-shaped.

3. The surface light source device of claim 1, wherein the V-shaped ridge structures extend along four different directions.

4. The surface light source device of claim 3, wherein each three V-shaped ridge structures extending along different directions cooperatively define a micro-dent, each of which comprises three side surfaces connected in order.

5. The surface light source device of claim 4, wherein each four adjacent micro-dents cooperatively define a first micro-protrusion, and each eight adjacent micro-dents cooperatively define a second micro-protrusion.

6. The surface light source device of claim 1, further comprising a transparent plate arranged above the second prism sheet and covers the housing, wherein the transparent plate prevents the second prism sheet from being contaminated, or scratched.

7. The surface light source device of claim 6, wherein the transparent plate is made of transparent glass, frosted glass, or transparent plastic.

8. The surface light source device of claim 1, wherein the housing further comprises a plurality of sidewalls extending from a periphery of the bottom plate.

9. The surface light source device of claim 8, wherein the sidewalls are made of metal or plastic material with high reflectivity rate.

10. The surface light source device of claim 8, wherein the housing has a high reflective coating applied on its internal sidewalls for improving light reflectivity rate.
